(19) United States
(12) Patent Application Publication
(10) Pub. No.: US 2017/0270243 A1
(43) Pub. Date: Sep. 21, 2017

(54) METHOD FOR FINDING ASSOCIATED POSITIONS OF BASES OF A READ ON A REFERENCE GENOME

(71) Applicant: Genalice B.V., Harderwijk (NL)

(72) Inventor: Johannes KARTEN, Harderwijk (NL)

(21) Appl. No.: 15/322,087

(22) PCT Filed: Jul. 3, 2015
(86) PCT No.: PCT/NL2015/050489

§ 371 Date: Dec. 23, 2016

(30) Foreign Application Priority Data
Jul. 3, 2014 (NL) 2013120

(51) Int. Cl. G06F 19/22

(52) U.S. Cl. CPC G06F 19/22

(57) ABSTRACT

In finding associated positions of bases of a read on a reference genome, each base has a position number on the read. A procedure to obtain P sequence parts of the read comprises a first loop to obtain P candidates and extend each of the P candidates by preceding and/or following bases of the read to obtain the P sequence parts. A sequence part matches a part of the reference genome according to predefined criteria at a location on the reference genome. The first loop comprises determining the number of locations on the reference genome that match a partial sequence with a length of M bases, the partial sequence starting at a base with position number S and repeating that action by increasing M as long as the number of locations on the reference genome that match is larger than a predefined number T, where P≦T.

### TECHNICAL FIELD

The invention relates to a method for finding associated positions of bases of a read on a reference genome. More particularly, the invention relates to the process of finding for each read a subdivision of one or more sub-sequences wherein the one or more sub-sequences have the best matching on corresponding positions on a reference genome.

### BACKGROUND

A genome exists of 4 different nucleotides or bases which form a string. The codes for these nucleotides are A C G T. These strings are connected where AT and CG form pairs. The bases can be encoded using two bits: 00-A, 01-C, 10-G, 11-T. The human genome exists of 3.2 Billion base pairs. With an encoding of 2 bits per genome position, the entire genome can be stored in ˜750 Mb.

When alignment software looks for a pattern in the genome, the alignment software needs to compare the presented pattern with each possible pattern in the genome. When the software wants to ‘match’ a 50base pattern, i.e. a sequence or string of 50 bases, the software needs to compare this pattern with the pattern in de genome at position 1 then at 2, then at 3 at 4 etc. The genome is in the context of the present application regarded to be the reference data. A read, which is a sequence of M bases, is in the context of the present application regarded to be a data pattern for which the location on the reference data has to be found.

When the software finds a match, the software still has to look further, since there can be other locations in the reference data matching the pattern as well. Such pattern with more than one matching location in the reference data is called a repeat.

When the pattern does not match, the software must search for a partly match of the pattern in the reference data, so the software has to look again, but now with a fuzzy pattern to be able to locate the position.

Dutch patent application NL2011817 of the present applicant, which is incorporated herein by reference, discloses an efficient method for finding a position of a data pattern (read) in a reference data structure (genome). The method is very efficient to find the position(s) on the reference genome with a perfect match, i.e. the position(s) on the reference where all bases of the read match a part of the reference data structure.

However, not all reads perfectly match a position on the reference data structure. There is a difference in genome sequence even in the same species due to various genetic variations. Due to an error made in sequencing, there may also be a difference in genome sequence. The read could comprise a Single Nucleotide Polymorphism (SNP; plural SNPs), a deletion of one or more bases, an insertion of one or more base, a break. Single Nucleotide Polymorphism (SNP, pronounced snip; plural snips) is a DNA sequence variation occurring commonly within a population (e.g. 1%) in which a Single Nucleotide—A, T, C or G—in the genome (or other shared sequence) differs between members of a biological species or paired chromosomes.

EP2725509A1 discloses a method and system for aligning a genome sequence. The system produces a plurality of fragment sequences from a read sequence. A set of candidate fragment sequences only including those of the plurality of the produced fragment sequences matching a target sequence is formed. The number of mapping positions of each of the candidate fragment sequences to the target sequence is calculated. A fragment sequence is selected in which the calculated number of mapping positions is higher than a predetermined value. The selected fragment sequence is elongated until the number of mapping positions to the target sequence approaches the predetermined value or less. The target sequence is divided into a plurality of sections. A total mapping length of the candidate fragment sequences by sections is calculated. A section in which the calculated total mapping length is a reference value or more is selected. Finally, a global alignment of the read sequence with respect to the selected section is performed to determine whether the alignment is successful.

US2011/270533 discloses methods which initially map only a contiguous portion of a read to a reference sequence and then extends the mapping of the read at both ends of the mapped contiguous portion until the entire read is mapped. The extension step finds the best ungapped local alignment for each read. The disclosed method is not suitable for reads which alignment comprises one or more gaps. A gap can be a very large deletion or a break or a translocation.

### SUMMARY

It is an objective of the invention to provide an improved method for processing a read to find associated positions of bases of the read which not perfectly matches on a reference genome. The improvement is at least one of: efficiency, mapping quality, reduced processing power, reduced processing time and reduced CPU usage.

According to the invention, this objective is achieved by a method having the features of claim 1. Advantageous embodiments and further ways of carrying out the invention may be attained by the measures mentioned in the dependent claims.

According to a first aspect of the invention, there is provided a method for processing a read to find associated positions of bases of a read on a reference genome. Each base has a position number on the read. The method comprises a first procedure to obtain P sequence parts of the read. The first procedure comprises 1) a first loop to obtain P candidates and 2) extending each of the P candidates by preceding and/or following bases of the read to obtain the P sequence parts, a sequence part matches a part of the reference genome according to predefined criteria at a location on the reference genome. The first loop comprises the actions: 1A) determining the number of locations on the reference genome which perfectly matches a partial sequence with a length of M bases from the read, the partial sequence starting at a base with position number S; and 1B) repeating the previous action 1A) by increasing the value of M as long as the number of locations on the reference genome which perfectly matches is larger than a predefined number T to obtain the P candidates, where P≦T. The first procedure is subsequently performed on a remaining sequence part (309) to obtain a subsequent sequence part, a remaining sequence part comprises the bases of the read that follows a sequence part obtained by the first procedure.

The idea is to find all sequence parts of the read with a predefined minimum number of neighbouring bases which perfectly matches a part of the reference genome. However, if the number of matching locations on the reference genome of a sequence part is above a predefined level T, this is an indication that the sequence part is a repeat on the reference genome. A repeat is a pattern of nucleic acids (DNA or RNA) that occur in multiple copies throughout the genome. They can be compared to articles or pronouns (e.g. word ‘the’ or ‘she’) in human language. Taking into account all these positions would increase the complexity and processing power significantly to find the best mapping of the complete read on the reference genome. By increasing the length of the sequence part, bases neighbouring a repeat will be taken into account, resulting in less possible positions on the reference genome and consequently a reduction of the complexity and processing power to find the best mapping. The limited number of matching positions is subsequently used to extend the sequence part of the read with neighbouring bases such that the extended sequence part comprises a predefined maximal deviation from a corresponding sequence part on the reference genome. In this way, the complexity to map the entire read on the reference genome is reduced as only the remaining part of the read has subsequently to be mapped on the reference genome. The initial value of M determines the sensitivity of the possible positions that could be found. The processing of the remaining part by the same process enables evaluating all possibilities to map an entire read on a reference genome such that all parts of the read that map on the reference genome have a minimum sequence part that perfectly matches the reference genome. This improves the reliability and/or quality of the mapping results. Furthermore, the method enables to perform an exhaustive search for mapping results.

In a further embodiment, a best mapping score is assigned to a combination of a sequence part and N subsequent sequence parts. The best score is a measure of similarity between bases of the read and corresponding locations on the reference genome belonging to a combination of a sequence part and N subsequent sequence parts aligned with the reference genome having the best measure of similarity of all currently processed combinations of sequence parts and N subsequent sequence parts. The method further comprises: calculating a mapping score for a combination of a sequence part, corresponding sequence parts and a remaining score for the remaining sequence part; and, stop performing the first procedure on the remaining sequence part if the sum of mapping score and remaining score is smaller than the best mapping score. These features enable to reduce the processing time by not processing/mapping the remaining part of a read in case the total score of all sequence parts of the current mapping could not exceed the total score of a previously find mapping of the read on the reference genome.

In an embodiment, the following bases include at most 2 SNPs. In a further embodiment, the preceding bases include at most 1 SNP. These characteristics could easily be implemented with minimal processing power as the location on the reference genome is known before extension and a deviation of a value of a base of the read from the corresponding value of the base in the reference genome could easily be detected. No complex searching algorithm is needed as in other mapping algorithms.

In an embodiment, each of the P sequence parts has a last base with a position number on the read, the first procedure is repeated with partial sequences starting at a base with a position in the range [S+1, L], where L corresponds to the position number of the last base of the P sequence parts having the lowest position number. These features provide another mechanism to reduce the processing time by limiting the mapping to sequence parts that not have been mapped before in the process to find the mapping with the highest score.

In an embodiment, the first procedure is repeated with partial sequences starting at a base with position numbers S+Step, S+2×Step, . . . , S+k×Step, where k is an integer >0. This feature enables to reduce the processing time without reducing the mapping quality significantly.

In an embodiment, the read comprises a forward version and a reverse-complement version, the first procedure is performed on both the forward version and reverse complement version of the read. This feature is possible when using for example the method described in Dutch patent application NL2011817 to find all the perfectly matching positions on the reference. By having a complete reference index a matching location on the reference genome for both a forward version as a reverse-complement version can easily be found. Having this option increases the quality of the mapping result.

According to a second aspect, there is provided a processing device comprising a processor, an Input/Output device to connect to the network system, a database and a data storage comprising instructions, which when executed by the processor cause the processing device to perform any of the methods described above.

Other features and advantages will become apparent from the following detailed description, taken in conjunction with the accompanying drawings which illustrate, by way of example, various features of embodiments.

### BRIEF DESCRIPTION OF THE DRAWINGS

These and other aspects, properties and advantages will be explained hereinafter based on the following description with reference to the drawings, wherein like reference numerals denote like or comparable parts, and in which:

FIG. 1 illustrates a flow diagram of a first process in a method for finding positions of bases of a read on a reference genome;

FIG. 2 illustrates a flow diagram of a second process;

FIG. 3 illustrates a flow diagram of a third process;

FIGS. 4 and 5 illustrate the method by means of a simplified example; and,

FIG. 6 is a block diagram illustrating a computer implemented system.

### DETAILED DESCRIPTION

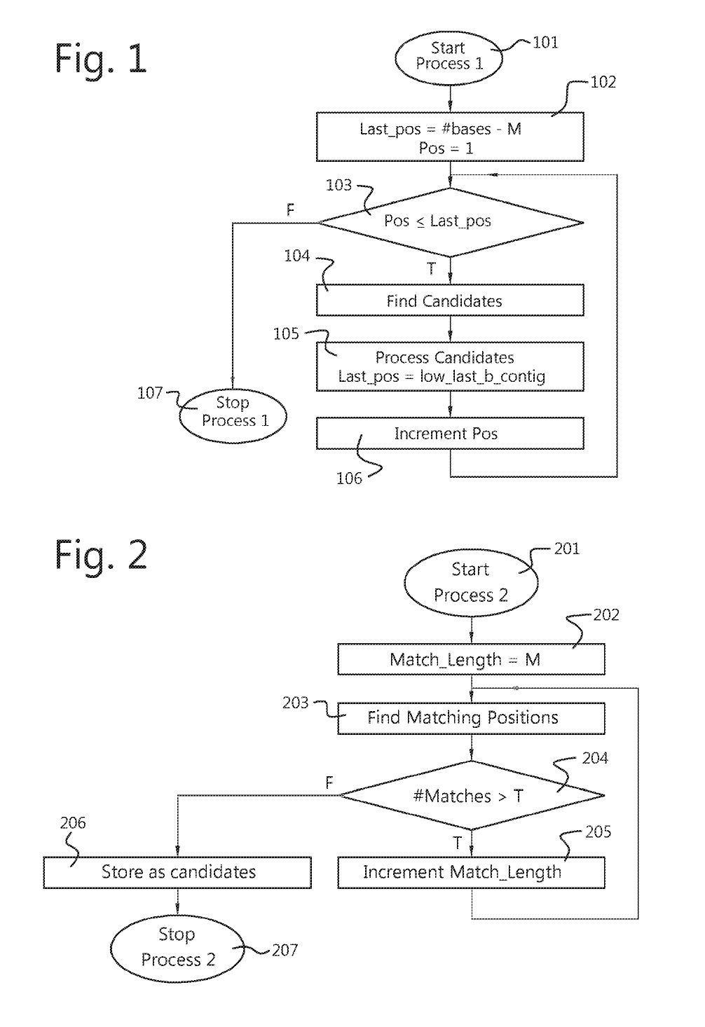

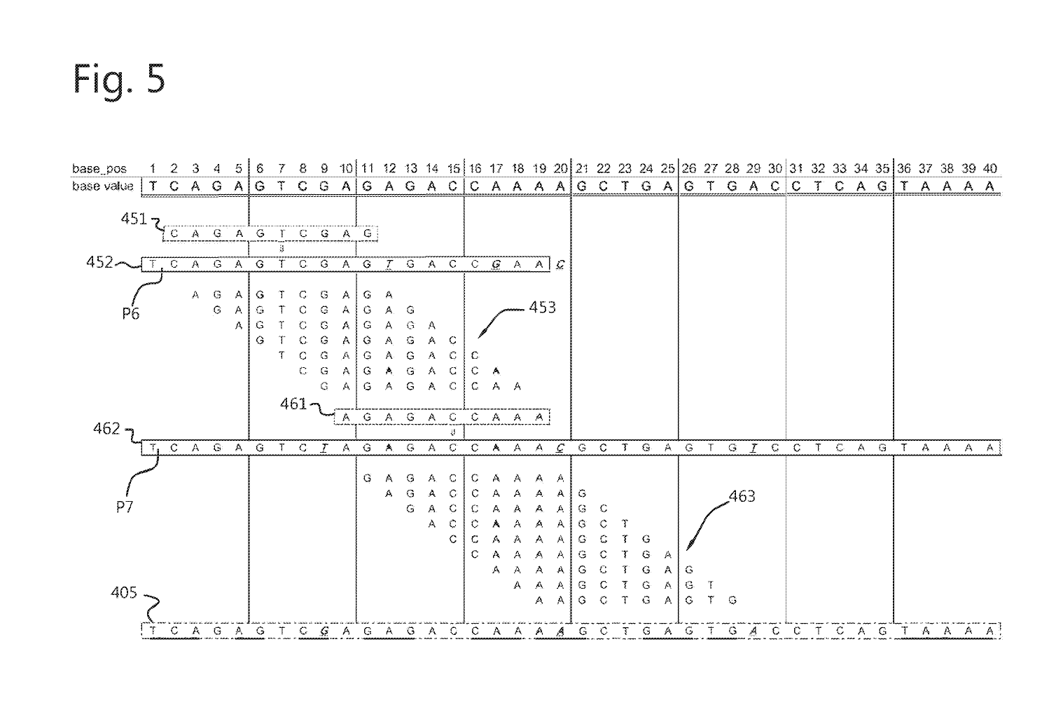

The basic processes for finding associated positions of bases of a read on a reference genome will be described below with reference to FIGS. 1-3. The processes will be elucidated with a data example in FIGS. 4 and 5.

Prior to describing exemplary embodiments in detail, terms to be used herein will be defined.

First, the term “read sequence” (or abbreviated as “read”) is a short-length genome sequence data output from a genome sequencer. A length of the read sequence varies generally from 35 to 500 base pairs (bp) depending on a kind of the genome sequencer, and generally expressed as four letters, A, C, G and T in the case of DNA.

The term “reference genome” (or abbreviated as “reference”) refers a database describing the genome as a sequence of bases. When mapping read on the reference genome, the position on the reference of one or more sequence parts of the read is searched which has the best similarity.

The term “base” is the minimum unit constituting a target genome sequence and a read. As described above, DNA is expressed with four letters such as A, C, G and T, each of which is called a base, and so is the read sequence.

The main problem with mapping DNA or RNA sequences on a reference genome which do not perfectly match a part of the reference genome is that it is not known which bases have a different value due to variation in the population, these are the so called Single Nucleotide Polymorphism (SNP; plural SNPs), where probably one or more bases have been inserted or deleted or when a read is a combination two or more sequences of bases which have complete different positions on the reference genome. It is unrealistic to generate for each possible variation for the read a trial sequence and to evaluate whether there is a perfect match of the trial sequence on the reference genome. This approach would make the alignment process very complex.

The first problem that has to be solved is to limit the number of possible partial sequences that have to be aligned with the reference. In the present method, the starting sequence to compare the read with the reference is a sequence part with a minimum length of M bases. It has been found that a minimum length of 24 bases is very suitable for mapping human data.

For this partial sequence of M bases, the positions on the reference are looked up which perfectly match with the partial sequence by means of well-known search algorithms. A very fast method to find the matching positions is described in Dutch patent application NL2011817. If the length of the partial sequence is too short, than a lot of positions will be found, which will increase the number of possibilities that have to be verified, which increases the necessary processing power. If the length is too long, only a few matches or even no match could be found which results in alignment results that are not suitable for further processing such as variant calling. For example, sequences that correspond to a position on the reference genome where the distance between SNP's is smaller than M, will hardly be mapped on the correction position. To restrict the number of positions on the reference genome that have to be compared with the read, according to the present method, the initial length M is chosen such that the partially matched sequence is reasonably distinct. If necessary, the number of possible positions is decreased by increasing the length of the partial sequence with one or more subsequent bases until the number of perfectly matching positions is below a predefined number T. This results in P candidate positions on the reference, where P≦T. To obtain the best mapping, the procedure described above has to be performed for each possible partial sequence with minimum length M. The initial value, i.e. the lowest value of M, defines the sensitivity to find matching locations on the reference. By increasing the value of M, the unicity of the perfectly matching part of the sequence increases and simultaneously the quality in terms of reliability of the mapping.

As the partial sequence perfectly matches the reference genome and the corresponding P positions on the reference are known, the partial sequences could easily be extended with following bases and/or preceding bases to determine whether a base matches or not. It is further possible to define criteria for the following bases and/or preceding bases. A criterion could be that the sequence of following bases comprises a predefined number of SNP's. A number of two SNP's has been found suitable for the sequence of bases following the partial sequence and only one SNP for the sequence of base preceding the partial sequence. Depending on the type of DNA/RNA material other values might be used. It is further possible to use a criterion wherein the partial sequence is extended with a sequence of bases which comprises two neighbouring bases which values differ from the reference. This extension of the partial sequence for each candidate position increases the quality of the mapping result and reduces the complexity to find the best mapping as the number of remaining bases of the read, i.e. the bases that follow the extended partial read, for which a mapping position on the reference has to be found is reduced. For the sequence of remaining bases the mapping process described above is repeated until the number of remaining base is smaller than the initial length M. At this stage a final mapping score could be determined for the combination of one or more extended partial sequences that have been mapped on the reference. In the following description the word “score” will refer to “mapping score”. If there are more than M remaining bases, for these sequences a remaining score could be calculated. This remaining score corresponds to the value in the case the sequence of M remaining bases perfectly matches the reference. An intermediate score could be calculated for the combination of already mapped extended partial sequences of the read. The score is a measure indicating the similarity of the read and the reference after alignment/mapping. For example, the length of the extended partial sequences could be multiplied with a predefined value F_{length}, for example F_{length}=10. Any SNP in the extended partial sequence decreases the score with a predefined value F_{SNP}, for example F_{SNP}=1. Furthermore, the distance between the extended partial sequences could be taken into account to calculate the score. The longer the distance the lower the score will be. It might be clear that the function to determine the score could easily be adapted by the skilled person without changing the concept of finding the extended partial sequences according to the present application.

Goal of the present method is to find the partitioning of a read in extended partial sequences with the best score. During the search for the best result, there is always one combination of already found extended partial sequences with the currently highest score max_tmp. This currently highest score or best mapping score is used to determine whether mapping of the sequence of remaining bases if necessary. If the combination of the intermediate score of the one or more extended partial sequences and the maximal possible score for the sequence of remaining bases is lower than the currently highest score, mapping of the remaining bases does not make sense. This mechanism decreases the processing time significantly without decreasing the quality of the mapping result.

FIG. 1 illustrates a flow diagram of a first process used in the method for finding positions of bases of a read on a reference genome. The first process ensures that a search is performed for a perfect match for any sequence of M bases from the read. For human data, the values 16, 20 and 24 have been found very suitable.

Action 101 indicates the start of the first process. Input of the process is a sequence of bases, for example a whole read or a part of a read. In the current description, the first base has position number 1 and the second base has position number 2, etc. In action 102, variable Last_pos obtains the value corresponding the number of bases, #bases, of the sequence minus an initial value M. The initial value M corresponds to the minimum length of a sequence for which a perfect match has to be found on the reference. Furthermore, variable Pos is set to 1. The variable Last_pos is used to define the highest position number on the read of the first base of a partial sequence of M bases for which a perfect matching position has to be found on the reference.

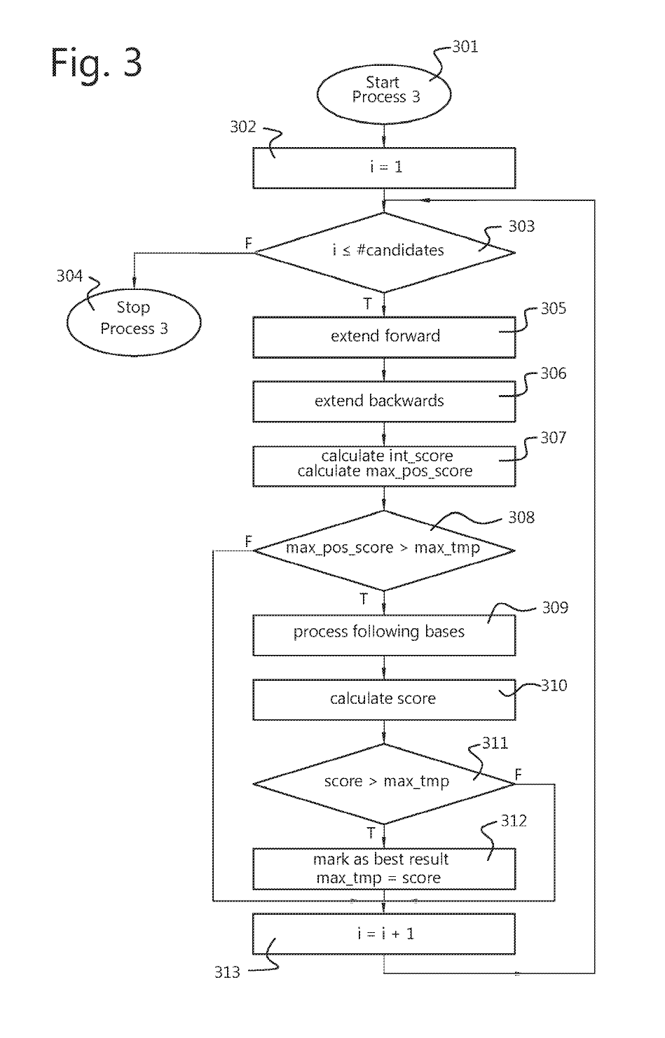

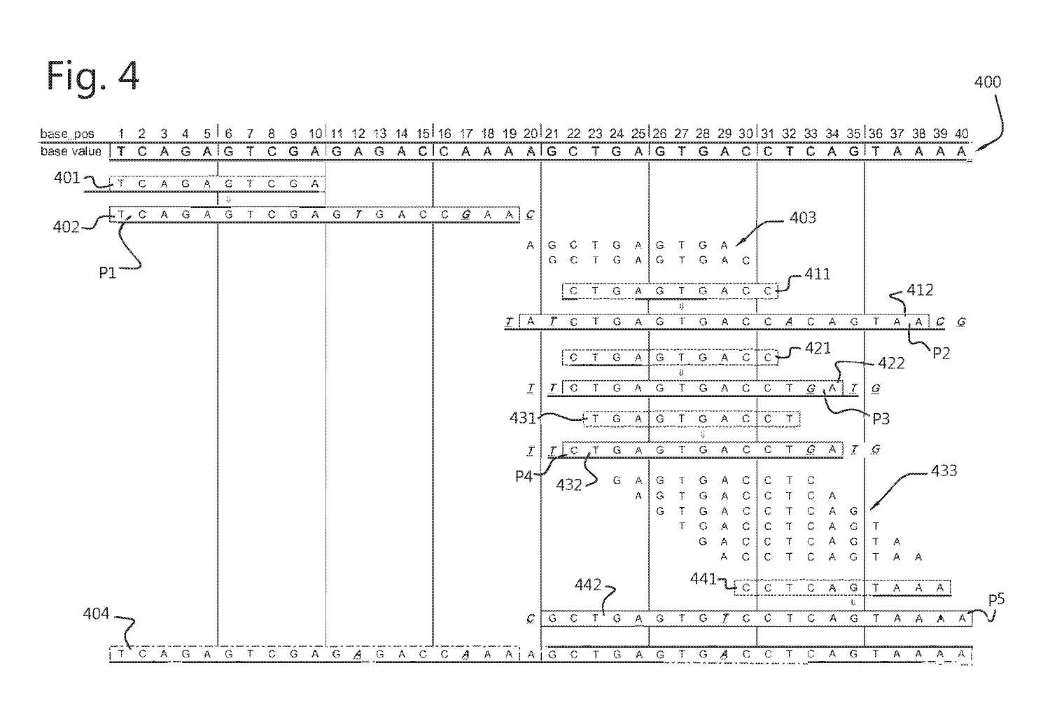

In action 103, is verified whether the value of Pos is smaller than or equal to the value of Last_pos. If false, the method proceeds with action 107 where the first process is ended. If true, the method proceeds with action 104. In action 104, a second process is started. The second process will be described below in further detail with reference to FIG. 2. In the second process, a search is performed for perfectly matching positions on the reference for a partial sequence of the read which starts at the position indicated by the variable Pos and with a minimum length of M bases. The second process outputs P candidate positions on the reference genome which perfectly matches a partial sequence of the read, wherein the first base of the partial sequence has a position with value Pos on the read, where P≦T and T is a user defined process constant. Subsequently, in action 105, the P candidate positions and candidate sequences are further processed to obtain P sequence parts and to process the bases of the read following each of the P sequence parts. This further processing is described below with reference to FIG. 3, which discloses a flow diagram of a third process. The P sequence parts correspond to the P candidate sequences which are extended with following and optionally preceding bases of the read such that the P sequence parts matches a part of the reference genome according to predefined criteria at the corresponding P candidate locations on the reference genome. After finding a sequence part, the bases of the read following the sequence part are mapped on the reference to find also the location(s) on the reference which has the best similarity with the reference. Furthermore in action 105, after finding the P sequence parts of the reads, the position number of the last base of each sequence part is determined. In literature, such a sequence part is also referred to as “contig” or “contiguous sequence”. The position number of the last base of the P sequence parts with the lowest position number of the read (low_last_b_contig) is assigned to the parameter Last_pos, in case low_last_b_contig is smaller than #bases—M. The assignment restricts the start of the second process on sequence parts of the read which could provide a mapping of the read on the reference genome with a better similarity score. The restriction is based on the insight that the sequence of bases following the partial sequence which last base has the lowest position number of the read could never have a better similarity value than the similarity value of the partial sequence and the sequence of bases following the partial sequence.

At the end of action 105, one combination of one or more subsequent partial sequences formed by the bases of the read of the evaluated combinations of one or more subsequent partial sequences is assigned to be the combination having the best similarity value. The mapping of the combination of partial sequences having the best similarity value and its score, i.e. the similarity value, is stored in a memory. Furthermore, at the end of action 105, all combinations of one or more subsequent partial sequences with a first partial sequence which first base has a position number Pos or lower position number have been evaluated.

After action 105, the variable Pos is increased with a user definable value in action 106. Preferably, the variable Pos is increased with the value 1. However, to reduce the processing time and power, variable Pos could be increased with an integer value larger than 1. This could result in missing the best mapping result. The best mapping result is the mapping of one the bases of the read on the reference as one or more sequence parts at one or more locations, where the difference between base values of the read and corresponding base values on the reference is minimally. After action 106, the process returns to action 103, which verifies whether the incremented value of Pos is still smaller than parameter Last_pos. At the end of first process, action 107, the mapping of a sequence of bases comprising the bases from a specific position and higher and with the best similarity is known.

It should be noted that it might be possible that after incrementing the Match_length no perfect matches might be found. In that case, in an embodiment all candidate locations that have been found before incrementing the Match_length will be further processed to find the mapping with the best similarity and thus more than T candidate locations on the reference will be analysed.

FIG. 2 illustrates a second process for use in a method finding associated positions of bases of a read on a reference. This process corresponds to action 104 in FIG. 1. At the start of process 2, action 201, the position number on the read of the first base of a partial sequence for which a perfectly matching location on the reference genome has to be found is inputted. Subsequently, in action 202, the variable Match_length is set to the value M. M is a user definable value, which corresponds to the initial length of a partial sequence of the read for which a matching location is searched for on the reference genome. The initial length M is chosen such that the partially matched sequence is reasonably distinct. For human data an initial length of 16, 20 and 24 bases has been found suitable. Subsequently, in action 203, the number of locations on the reference genome which perfectly match the partial sequence with a number of bases which is defined by the parameter Match_length and which partial sequence starts with the base having the position number defined by parameter Pos, is determined. For finding a perfectly matching location, software is available on the market. A very fast method to find the matching positions is described in Dutch patent application NL2011817. In action 204, the number of perfectly matching locations #Matches is compared with a user defined parameter T. Parameter T defines the maximum number of matching location of partial sequences that will be processed in action 105 as candidates. The idea is that if the number of matching locations is higher than T, the partial sequence is not distinctive enough to allow further processing. If #Matches >T, in action 205 parameter Match_length is increased with a user specified value, for example 1, 2, 4 and the process returns to action 203. In this way, the length of the partial sequence starting at position of the read defined by Pos is increased to make the partial sequence more specific and distinctive until the number of matching locations on the reference genome is less or equal to T. In this condition is detected in action 204, the process proceeds with action 206. In this action the matching locations are stored as candidate locations which will be further processed in action 105. In action 206 a third process is performed which will be described below with reference to FIG. 3.

The third process start with action 301. Inputs of this procedure are the candidate locations, the value Pos, the value of Match_length, the read and the reference genome. In action 302, variable i is set to 1. Variable i indicates which of the P candidates is currently processed. For each candidate location the actions 305-313 are performed.

If not all candidate locations are processed, which is tested in action 303, the process proceeds with action 305. In action 305, the partial sequence of the read starting at position Pos of the read and having a length of Match_length, is extended forward with following bases. The partial sequence is extended as long as the extended partial sequence of the read complies with predefined criteria with respect to its similarity with the reference. Examples of criteria are: the extension of bases stops when the number F of SNPs in the sequence part following the partial sequence with length Match_length exceeds a user definable value, and stops when at least two neighbouring bases of the read do not match the value on the reference at corresponding positions on the reference. For human data, the number of SNPs in the following part is at most 2.

In action 306, the partial sequence of the read starting at position Pos of the read and having a length of Match_length, is extended backwards with bases preceding position Pos. The partial sequence is extended as long as the extended partial sequence of the read complies with predefined criteria with respect to its similarity with the reference. An example of a criterion for extending backward is the extension of bases until the number B of SNPs in the sequence part preceding position Pos exceeds a user definable value. Another example is that the extension stops when at least two neighbouring bases of the read do not match the value on the reference at corresponding positions on the reference. In this way an extended sequence part is obtained, which comprises a sequence of bases with length Match_Length which perfectly matches the reference and probably one or more preceding/following bases which could comprise a predefined number of SNP's.

After extension of the partial sequence to obtain the extended partial sequence in action 307 an intermediate score int_score is calculated for the combination of the current extended partial sequence part and if present extended partial sequence parts preceding the current extended partial sequence part. Furthermore a maximum remaining score is calculated for the bases following the current extended partial sequence part. The score is a measure of similarity between the sequence part and a location on the reference genome. In an embodiment, the score of an extended sequence part is the number of bases of the extended sequence part multiplied with 10 minus the number of SNP's in the extended sequence part. The maximal possible score max_pos_score is the sum of the intermediate score int_score plus the maximum remaining score. In general the maximum remaining score is the score wherein the sequence of following bases perfectly matches the reference. With the embodiment above, the maximum remaining score is the number of following bases multiplied with a factor 10.

In action 308, the maximum possible score max_pos_score is compared with the value max_tmp. The value max_tmp corresponds to similarity score of the mapped constellation of extended partial sequence parts which has the best similarity score. If the value of max_pos_score is less them max_tmp, the sequence of bases following the current extended partial sequence part don't have to be mapped on the reference as the score belonging to combination of extended sequence parts and mapped remaining sequence part will never exceed the score of the combination of extended partial sequence part with the current best similarity score. In other words, by action 308 the method stops performing the first procedure on the remaining sequence part when the sum of the intermediate score and the maximum remaining score is smaller than or equal to the best score max_tmp. In this case, the process proceeds with action 313, where the parameter I is increased with one and the procedure returns to action 303, which tests if all candidate locations have been processed. However, if max_pos_score>max_tmp, the sequence of bases following the current extend sequence part will be processed in action 309. Action 309 corresponds to the process disclosed in FIG. 1. At the end of action 309, a final score can be calculated for the sequence of bases following the current extended partial sequence part and extended sequence parts prior to the current extended partial sequence part. In action 311, the final score is compared with the value of max_tmp. If the final score is larger than max_tmp, the last determined combination of extended partial sequence parts has better similarity than any of the previously determined combination of extended partial sequence parts. In that case, the last determined combination of extended partial sequence parts will be marked as best result in action 312 and together with the final score stored in a memory. After action 312 and if the final score is smaller than or equal to the value of max_tmp, the process proceeds with action 313 where variable i is increased with 1. In the next loop comprising the actions 303-313, the next candidate location on the reference will be used to extend the sequence part of the read starting with a base at position number Pos and a length Match_Length. The loop is repeated until the last candidate location is processed to determine is corresponding best similarity score.

FIGS. 4 and 5 illustrate the method the method described above by means of a simplified example. On top of the Figs a read 400 is described giving the value of the bases and their corresponding position number on the read. The read 400 is a sequence of 40 bases and start with a base with value T at position 1. In the present example the initial value M for parameter Match_length in the second process is set to 10 bases. Reference 401 indicates the partial sequence of the read which first base has position number 1 and which has a length of 10 bases. The dashed border around a partial sequence of 10 bases indicates that a perfectly matching location is found on the reference genome. After processing the sequence 401 by the second process, one candidate location on the reference has been found. This candidate location is in the third process used to extend the partial sequence with following and preceding bases as long as the partial sequence complies with predefined criteria. In the present example, the sequence of following base might comprise at most two SNP's and the sequence of preceding bases might comprise at most one SNP. Sequence 402 shows the sequence of bases that are at location P1 on the reference genome. It can be seen that the partial sequence of 10 bases could be extended by action 305 in FIG. 3 with nine following bases to a sequence of 19 bases. The bases at position 12 and 17 of the read have a base value that differs from the corresponding base of the reference. The extending process is stopped by the third base that differs from the reference, in the current example the base at position 20 of the read. In FIGS. 4 and 5, the values of the bases of the reference which differ from the value of the corresponding bases of the read are written in italic and are underlined. The solid borderline around a sequence of bases indicates the sequence of bases at the reference which matches a corresponding extended sequence part of the read which complies with the predefined criteria. Subsequently a similarity score is calculated for the extended sequence part (action 307 in FIG. 3). In the present example the score of an extended sequence part is obtained by multiplying the length of the extended sequence part by 10 and subtracting the number of bases of the read having a value differing from the reference. The similarity score for the sequence 402 is 19×10−2=188. As this score is the best till know, the extended sequence part is marked as best matching result with score 188. The value 188 is assigned to the parameter max_tmp in the third process. The extended sequence part is followed by a sequence of bases with position number 20-40. This remaining sequence of bases could also have a sequence part with a corresponding mapping location on the reference which complied with the predefined criteria. For the remaining sequence a maximum possible score is calculated which value corresponds to the number of following bases multiplied with 10. This score corresponds to the situation that the sequence of bases has a perfect match with a location on the reference. The maximum possible score (max_pos_score) for the remaining sequence of following bases is 21×10=210. The best similarity score that could be obtained with the extended sequence part 402 and following bases is 188+210=398. In view of the present maximum score stored as parameter max_tmp, processing of the sequence of following bases from the read could result in a better similarity score. Therefore, the first process shown in FIG. 1 is started for the sequence of following bases. Reference numeral 403 refers to partial sequences of the read starting at position 19 and 20 having a length of 10 bases. For these partial sequences no location is found on the reference which perfectly matches. The next partial sequence with length of M—10 bases that perfectly matches at least one location on the reference has a first base at position 22 of the read. Reference sign 411 indicates the first candidate location and reference 421 indicates the second candidate location on the reference. Subsequently, the partial sequence is extended at the first candidate location on the reference. The sequence of bases at said location P2 is indicated with reference sign 412. A box with solid line surrounds the part of the reference genome that matches a corresponding sequence part of the read according to the predefined criteria. The sequence of 10 bases which perfectly matches at location P2 on the reference is extended with seven following bases and two preceding bases. The sequence of following bases comprises 1 base having position number 32 on the read which value T differs from the base value A of the reference. The extension of following bases is stopped by detecting two subsequent bases which values on the reference differ from the corresponding base values of the read. The sequence of two preceding bases comprises one base having position number 21 on the read which value G differs from the corresponding base value T on the read. It should be noted that the extension of preceding bases stops when a base is reached which is already mapped on the references. This base is the last base of the extended sequence part 402. Furthermore it should be noted that the value of the last added base during extension has always the same value as the corresponding base value on the reference. Next, the similarity score is calculated for the second extended sequence part 412. The similarity score is 188. The total similarity score of the first extended sequence part 402 and second extended sequence part 412 is 376. Furthermore, the maximum score for the bases following the second extended sequence part is calculated. However, as the number of base is less than 10, the maximum score is zero. The total similarity score of the extended sequence parts and maximum score the following bases score is higher than current value of max_tmp which is the score of only the first extended sequence part 402. Therefore, action 309, which corresponds to process 1, will be performed. As the number of bases is smaller than 10, i.e. the minimum sequence length to find a candidate location, no extended sequence part will be found in the remaining bases following the second extended sequence part. The combination of extended sequence part 402 and 412 will now be marked as best result and max_tmp will now obtain the value 376.

After this, the second candidate location P3 on the reference is processed. The obtained extended sequence part 422 includes the bases with position 22-34 of the read. The score of this extend sequence part is 129. The combination of the scores of extended sequence part 402 and 422 is 317. The max possible score following sequence part 422 is zero, as the number of bases is less than 10 and the total score is smaller than the value of max_tmp. The second and last candidate location is processed and consequently, the value Pos is incremented with 1, action 106 in FIG. 1, to find candidate locations with a sequence part of 10 bases with the first base at position 23. With this sequence part one candidate location and corresponding extended sequence part at location P4 on the reference is found. This location is similar to the location P3. Therefore, the score can't be higher than the score max_tmp of the currently marked as best result combination of extended sequence parts and as a result the value Pos is again increased with 1. No candidate locations are found for sequence parts of the read with a length of 10 bases with a first base position of 24-28. The corresponding sequences are indicated with reference sign 433.

For a sequence part 441 of the read with length 10 and first base position 30 one candidate location P5 is found. The extended sequence part 442 comprises 20 bases and one base differing with the reference at position 29 of the read. The similarity score for extended sequence part 442 is 199. As the total score 188+199=387 is higher than the value max_tmp, which is tested in action 311, the combination of extended sequence part 402 and extended sequence part 442 will be marked is best result and the value of max_tmp becomes 387.

Next, the value of Pos is increased by one and one possible candidate is found. The extended sequence part corresponding to this candidate is similar to extended sequence part 442. Now the processing of the bases following the extended sequence part corresponding to 402 is finalized and the value of Pos is increased with one. This further processing is illustrated in FIG. 5. Reference sign 404 indicates the best found result at this stage of the processing. The best result comprises two extended partial sequence parts and one base having position number 20, which is not mapped on the reference. The score of the best result is 387. Furthermore, as there was only one candidate for a sequence part of the read with a length of 10 bases and a first base having position number 1, the value Last_pos is set the position number of the last base of the extended sequence part corresponding to 402, which has value 19.

It might be clear that the current method is a recursive process wherein the first process finds candidate locations with the second process and wherein candidate locations are processed with the third process to obtain corresponding extended sequence parts of the read and a remaining sequence part which comprises the bases of the read following an extended sequence part. In the third process, the first process is started for processing the remaining sequence part.

Reference numeral 451 refers to a partial sequence of the read starting at position 2 and having a length of 10 bases. For this partial sequence a candidate location is found on the reference which perfectly matches. Subsequently, the partial sequence is extended. This extended sequence part 452 is similar to the extended sequence part 402 in FIG. 4. Thus further processing of the remaining bases after the sequence corresponding to the extended sequence part 402 will not provide a better similarity score.

No candidate locations are found sequence parts of the read with a length of 10 bases with a first base at positions 3-9. The corresponding sequences are indicated with reference sign 453.

For the sequence part 461 of the read with first base at position number 10 of the read a perfect match is found on the reference. The base values on the reference according to the extended sequence part 462 are shown. The extended sequence part has a length of 40 bases, which corresponds to the number of bases of the read 400. Three bases of the read at positions 9, 20 and 29 have a base value differing from location P7 on the reference. The corresponding similarity score is 40×10−3=397. After finding this extended sequence part, this sequence part will be marked as best result and max_tmp will obtain the value 397.

Subsequently, no candidate locations are found to be sequence parts of the read with a length of 10 bases with a first base at positions 11-19. The corresponding sequences are indicated with reference sign 463. After this, Pos is increased to 20, which is larger than the value of Last_pos, which has the value 19. As a result of this, action 103 is followed by the action to stop the first process and the best mapping result for the read 400 is found. The best mapping result, indicated with 405 is subsequently stored in a database for further processing. An example of further processing is so called “variant calling”. A method to store the mapping result in a database is described in undisclosed patent application NL2012222 in the name of the present applicant.

FIGS. 4 and 5, illustrates a simplified example of finding the best mapping result of a read. A read could be a forward strand or a reverse-complement strand. To find the best mapping of the read, the method should be applied to both the read values as obtained from for example the sequencer, which is assumed to be the forward version, and the reverse-complement version of the read values. The first process as shown in FIG. 1 should thus be applied on the forward version and the reverse-complement version. This could be done sequentially or in parallel.

The described method is performed on a computer implemented system. As the described method for matching data patterns as described in NL2011817 could process the stream of a sequencer in real time, it might be possible to integrate the alignment process which includes the process for finding associated positions of bases of a read on reference data in a sequencer.

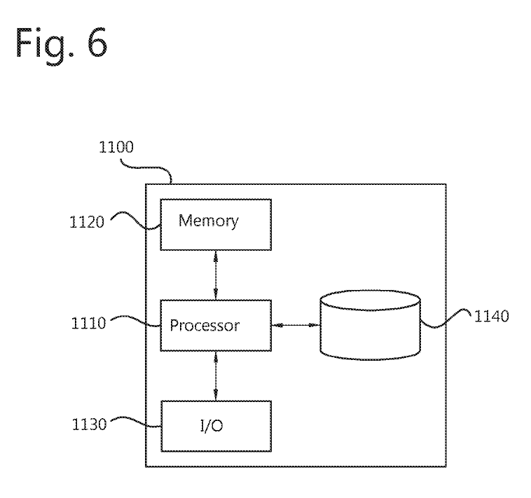

Referring to FIG. 6, there is illustrated a block diagram of exemplary components of a computer implemented system 1100. The computer implemented system 1100 can be any type of computer having sufficient memory and computing resources to perform the described method. As illustrated in FIG. 6, the processing unit 1100 comprises a processor 1110, data storage 1120, an Input/Output unit 1130 and a database 1140. The data storage 1120, which could be any suitable memory to store data, comprises instructions that, when executed by the processor 1110 cause the computer implemented system 1100 to perform the actions corresponding to any of the methods described in the present application. The data base could be used to store the reference index data structure, the data patterns to be matched and the results of the methods.

The method could be embodied as a computer program product comprising instructions that can be loaded by a computer arrangement, causing said computer arrangement to perform any of the methods described above. The computer program product could be stored on a computer readable medium.

In a human genome, repeats have a length of 8-16 bases. If M is smaller than 16, the processing effort to find at most P candidates will increase. SNPs occur on average about every 100 to 300 bases. However, in case of diseases, such as cancer, the distance between SNPs could be much smaller. To be able to map DNA of such a human more accurate, the value of M, i.e. the length of a perfectly matching partial sequence, should be in the range of 16-30.

It should further be noted that to calculate the similarity score of a read other parameters could be taken into account, for example: the distance between two subsequent sequence parts on the reference. Also other weight values could be used.

While the invention has been described in terms of several embodiments, it is contemplated that alternatives, modifications, permutations and equivalents thereof will become apparent to those skilled in the art upon reading the specification and upon study of the drawings. The invention is not limited to the illustrated embodiments. Changes can be made without departing from the scope and spirit of the appended claims.

1. A computer-implemented method for processing a read, each base of a read having a position number on the read, the method comprising:
a first procedure to obtain P sequence parts of the read, the first procedure comprising:
1) a first loop to obtain P candidates, the first loop comprising the actions:
1A) determining the number of locations on the reference genome which matches a partial sequence with a length of M bases from the read, the partial sequence starting at a base with position number S; and,
1B) repeating the previous action 1A) by increasing the value of M as long as the number of locations on the reference genome which perfectly matches is larger than a predefined number T to obtain the P candidates, where P≦T, characterized in that, in action 1A the number of perfect matches is determined, and the first procedure is performed on a remaining sequence part to obtain a subsequent sequence part, a remaining sequence part comprises the bases of the read that follows a sequence part obtained by the first procedure; and
2) extending each of the P candidates by preceding and/or following bases of the read to obtain the P sequence parts, a sequence part matches a part of the reference genome according to predefined criteria at a location on the reference genome.

2. The method according to claim 1, wherein a best mapping score is assigned to a combination of a sequence part and N subsequent sequence parts, the best score is a measure of similarity between bases of the read and corresponding locations on the reference genome belonging to a combination of a sequence part and N subsequent sequence parts aligned with the reference genome having the best measure of similarity of all processed combinations of sequence parts and N subsequent sequence parts; the method further comprises:
calculating a mapping score for a combination of a sequence part, subsequent sequence parts and a remaining score for the remaining sequence part, the mapping score is a measure of similarity between the alignment of the sequence part and subsequent sequence parts currently processed and the reference genome, the remaining score corresponds to an estimation of the maximum measure of similarity of the remaining sequence part; and,
stop performing the first procedure on the remaining sequence part if the sum of mapping score and remaining score is smaller than the best mapping score.

3. The method according to claim 1, wherein the following bases include at most F SNPs (Single Nucleotide Polymorphism), where F is a user definable integer number larger than 1.

4. The method according to claim 1, wherein the preceding bases include at most B SNPs, where B is a user definable positive integer number.

5. The method according to claim 1, wherein each of the P sequence parts has a last base with a position number on the read, the first procedure is repeated with partial sequences starting at a base with a position in the range [S+1, L], where L corresponds to the position number of the last base of the P sequence parts having the lowest position number.

6. The method according to claim 5, wherein the first procedure is repeated with partial sequences starting at a base with position numbers S+Step, S+2×Step, . . . , S+k×Step, where k is an integer >0.

7. The method according to claim 1, wherein, the read comprises a forward version and a reverse-complement version, the first procedure is performed on both the forward version and reverse complement version of the read.

8. A computer implemented system comprising a processor, an Input/Output device, a database and a data storage connected to the processor, the data storage comprising instructions, which when executed by the processor, cause the computer implemented system to perform the methods according to claim 1.

9. (canceled)

10. A non-transient computer-readable storage medium comprising instructions that can be loaded by a processor, causing said processor to perform the method of claim 1.
